(19) United States
(12) Patent Application Publication
(10) Pub. No.: US 2013/0238509 A1
(43) Pub. Date: Sep. 12, 2013

(54) Facility and Method for Increasing the Rate of Technological Innovation

(71) Applicant: David J. Muchow, Arlington, VA (US)

(72) Inventor: David J. Muchow, Arlington, VA (US)

(21) Appl. No.: 13/855,441

(22) Filed: Apr. 2, 2013

Related U.S. Application Data
(63) Continuation-in-part of application No. 13/072,584, filed on Mar. 25, 2011, now abandoned.
(60) Provisional application No. 61/282,743, filed on Mar. 25, 2010.

(51) Int. Cl. G06Q 10/10

(52) U.S. Cl. CPC G06Q 10/101
USPC 705/300

(57) ABSTRACT

A secure physical facility for promoting innovation development in a secure manner is provided. The facility includes separate physical areas accessible to inventors and service providers based on corresponding security policies. The facility includes an access control system that implements the security policies to control access to one of the physical areas assigned to the inventor, control access to the invention, and control access to physical areas assigned to the service providers, and restrict access to other physical areas. The facility also includes a computer network that includes servers to securely store information relating to the invention, implements the security policies to limit access to the information, and includes a security system that protects the computer network from cyber attacks originated from outside of the facility. The separate physical areas include a secure indoor or outdoor prototype demonstration and testing center for the inventor to develop and/or test a prototype.

### BENEFIT OF PRIORITY

This is a continuation-in-part application of U.S. patent application Ser. No. 13/072,584, filed on Mar. 25, 2011, which claims the benefit of provisional Application No. 61/282,743, filed on Mar. 25, 2010. The entire contents of all of the above-referenced applications are incorporated herein by reference.

### TECHNICAL FIELD

The present disclosure relates generally to facility and method for increasing the rate of technological innovation.

### BACKGROUND

Many valuable inventions fail to reach commercialization at a time when competition is strong in the race for new technologies. This is especially troubling considering the current emphasis on technologies to help countries regain competitiveness and create jobs. In addition, with the increasing use of the Internet and electronic data storage and computing, companies and individuals are becoming more susceptible to Internet cyber attacks against their computers. Important information regarding technological inventions developed by companies and individuals may be lost or stolen by hackers. When technological innovations cannot be carried out in a secure manner, a country's competitiveness in the global market may be impaired, which may ultimately threaten the country's national security.

Many inventions and products fail due to the vast amounts of time and money spent while developing an invention into a product. Steps such as developing a business plan, producing a prototype, and finding investors, customers, licensees, and distributors can be daunting. A major hurdle in the path from an idea to a successful commercial product, is that there is no central repository, either a virtual one (such as on the Internet) or a physical place for all of the necessary parties, disciplines, products, and services, to come together. These necessary elements may include financial, research, technical, design, engineering, prototyping, testing, business, legal, government parties, fabrication, marketing, etc. As a result, by the time a prototype of a product is developed, the developer, who may only have experience in one of these many disciplines, is likely to have spent a substantial amount of money or even decided not to continue. Further, for inventors who wish to develop inventions with classified national security, military, or intelligence uses, there are few easily accessible, highly secure facilities. Most activities in these fields are conducted by government contractors, such as Lockheed, IBM, and GE which generally do not provide secure access facilities to third party inventors.

In view of the foregoing, there is a need for an improved, secure system and method to help bridge the gap from invention to commercialization.

### SUMMARY

One aspect of the disclosure relates to a secure physical facility for promoting innovation development in a secure manner. The physical facility includes a plurality of separate physical areas within the physical facility accessible to inventors and service providers based on corresponding security policies, wherein one of the physical areas is assigned to an inventor and one or more physical areas are assigned to service providers who provide services relating to developing and commercializing an invention of the inventor within the physical facility. The physical facility also includes an access control system that implements the security policies to control access to the one of the physical areas assigned to the inventor, control access to the one or more physical areas assigned to the service providers, and restrict access to other physical areas within the physical facility. The physical facility further includes a computer network that includes servers to securely store information relating to the invention, implements the security policies to limit access to the information relating to the invention, and includes a security system that protects the computer network from cyber attacks originated from outside of the physical facility. The separate physical areas include at least one secure indoor or outdoor prototype demonstration and testing center for the inventor to develop and/or test a prototype of the invention.

Another aspect of the present disclosure relates to a method of expediting commercialization of innovation. The method includes providing a physical facility having a plurality of separate physical areas. The method also includes executing a confidentiality or non-disclosure agreement with an inventor who seeks assistance from the physical facility in developing and commercializing an invention. The method also includes evaluating the inventor and the invention to determine whether to admit the inventor to the physical facility. The method also includes granting access to the physical facility to the inventor who passes the evaluation. The method also includes assigning one of the separate physical areas to the inventor. The method further includes providing separate physical areas to service providers who provide services relating to developing and commercializing the invention within the physical facility, wherein the services include at least one of legal services, technical services, assistance on obtaining funding, commercialization assistance, testing, and prototyping. The inventor obtains services from at least one of the service providers to develop and commercialize the invention within the physical facility.

Another aspect of the present disclosure relates to a method of fostering continuing best practices in innovation. The method includes implementing a process to assist an inventor to develop and commercialize an invention within a physical facility, wherein the process includes services provided by service providers. The method also includes tracking an effect of the process implemented within the physical facility, and tracking a result of the invention after the process for assisting the inventor to develop and commercialize the invention has been completed. The method also includes collecting feedback from the inventor, service providers and others about the process implemented within the physical facility. The method also includes developing improvements to the process implemented within the physical facility based on information tracked or collected. The method further includes publishing the information tracked or collected and improvements developed to encourage continuous competition among other physical facilities engaged in similar operations.

Before explaining exemplary embodiments of the present disclosure, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as in the abstract, are for the purpose of description and should not be regarded as limiting.

The accompanying drawings, which are incorporated in and constitute a part of this specification, illustrate certain embodiments of the disclosure, and together with the description, serve to explain the principles of the disclosure.

As such, those skilled in the art will appreciate that the concept upon which this disclosure is based may readily be utilized as a basis for designing other structures, methods, and systems for carrying out the several purposes of the present disclosure. It is important, therefore, to recognize that the claims should be regarded as including such equivalent constructions insofar as they do not depart from the spirit and scope of the present disclosure.

### BRIEF DESCRIPTION OF THE DRAWINGS

FIG. 1 depicts an exemplary method for managing innovation;

FIG. 2 depicts another exemplary method for managing innovation;

FIG. 3 depicts another exemplary method for managing innovation;

FIG. 4 illustrates an exemplary floor plan of a first floor of an exemplary secure physical facility for promoting innovation;

FIG. 5 illustrates an exemplary expediting commercialization of innovation;

FIG. 6 illustrates an exemplary method o fostering continuing best practices in innovation;

FIG. 7 illustrates a helipad provided to the secure physical facility;

FIG. 8 illustrates an exemplary floor plan of a ground floor of the secure physical facility for promoting innovation;

FIG. 9 illustrates an exemplary indoor prototype demonstration and testing center and an exemplary outdoor prototype demonstration and testing center; and

FIG. 10 illustrates an exemplary access control system and an exemplary computer network implemented within the secure physical facility.

### DETAILED DESCRIPTION

Reference will now be made in detail to the present embodiments of the disclosure, examples of which are illustrated in the accompanying drawings. Wherever possible, the same reference numbers will be used throughout the drawings to refer to the same or like parts.

Embodiments of the present disclosure relate to managing innovation, including facilitating and managing communication between multiple parties interested in promoting innovation. Parties interested in promoting technology may include, but are not limited to inventors, sellers, licensors, distributors, grantors, government agencies, private companies, universities, stakeholders, buyers, researchers, angel investors, venture capital firms, banks and financial institutions, engineers, government representatives, business firms, law firms, mutual funds, business publications, public relations firms, marketing firms, scientists, media, volunteers, a government service corps of retired executives, and any combination thereof.

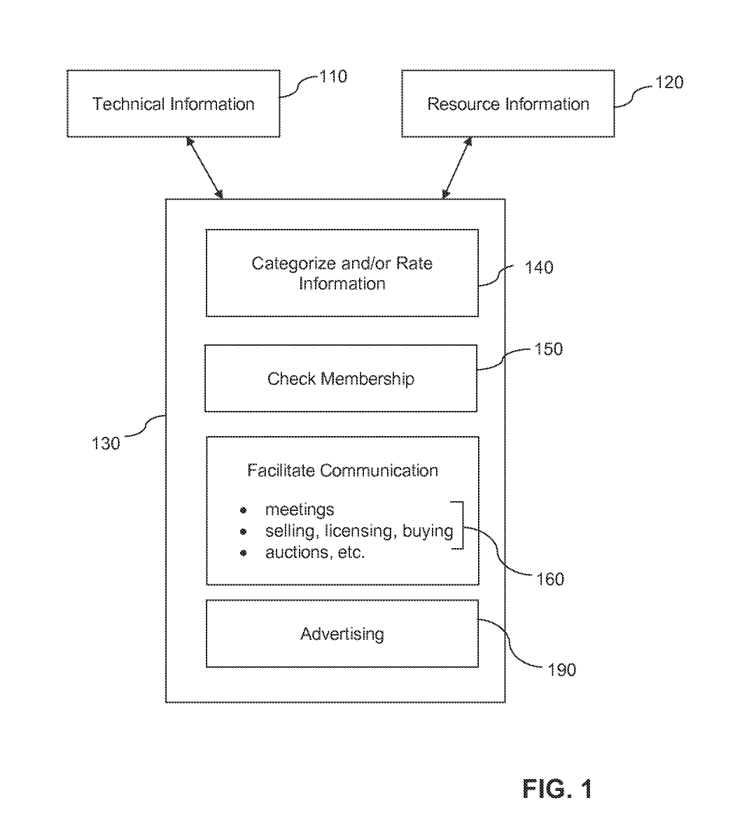

FIG. 1 illustrates one embodiment of the present disclosure. As further disclosed herein, this embodiment illustrates a method in which numerous parties may connect, interact, and share information and resources to help promote/develop innovation.

As shown in FIG. 1, a first party may have technology relating to a product that it wishes to promote/develop. This technology may be associated with a company or individual and relates to an uncommercialized product. For example, this technology may include ideas, inventions, or innovations relating to new or improved products. The technology may be of any type, including environmental technology (technology that applies the environmental sciences to conserve the natural environment and resources), mechanical technology, electrical technology, information technology, and may relate to national security. Associated with this technology, the first party may have information 110 regarding the same. This information may include, for example, technical information relating to the ideas, inventions, or innovations, and/or may be questions regarding how to develop, market, and/or protect the ideas, inventions, or innovations. The word “product” as used herein includes the product itself, services, and/or methods to make and/or facilitate making such a product or service. Further, the word “uncommercialized” used herein relates to products that are not currently a commercial product sold or owned by the first party. The terms “invention” and “innovation” used herein may be interchangeable.

A second party may possess resource information 120 for the development or promotion of the technical information 110. Resource information 120 may be associated with a company or individual and include, but is not limited to funding, advice, financing, proposals, research, and other types of product development support.

As further shown in FIG. 1, a first party with information 110, and a second party with resource information 120 may communicate and engage in a variety of tasks and activities in a virtual marketplace 130. Before the first party discloses the technical information 110 to the second party, the first party may require the second party to sign a confidentiality or non-disclosure agreement to protect the technical information 110. It is understood that the first party may include a plurality of first parties with different information 110, and the second party may include a plurality of second parties, each providing similar or different resources.

Virtual marketplace 130 may facilitate communication between e first party and the second party regarding the development of a product toward commercialization. Such communication may include a variety of transactions between the first and second parties regarding the development of the product. First and second parties may communicate with one another in virtual marketplace 130 via an electronic network (not shown), such as the Internet.

Virtual marketplace 130 may be associated with an entity that disseminates, publishes, generates, manages, or otherwise makes electronic content available over electronic network (not shown), such as the Internet. For example, virtual marketplace 130 may be associated with a content provider, a content publisher, a content creator, a search engine company, an Internet Service Provider (ISP), a mobile service provider, an online retailer, or any other entity concerned with providing electronic content over a network.

In addition, virtual marketplace 130 may be accessed through a website and include one or more server computers (not shown) connected to electronic network (not shown). Each server computer may include any combination of computing elements configured to facilitate communication and other various tasks and processes, consistent with embodiments of the present disclosure. For example, each server computer may include a central processing unit (“CPU”), a memory, a user interface, a data storage device, a network communication device, and/or any other computer elements known in the art.

First and second parties may access virtual marketplace 130 using a desktop computer, laptop computer, personal digital assistant (“FDA”), smartphone, mobile device, Internet-enabled television, automobile, or home, or any other mobile or electronic device configured to access electronic network. First and second parties may sign a confidentiality or non-disclosure agreement with the operator or owner of the virtual marketplace 130 to protect the technical information 110.

As further shown in FIG. 1, according to one aspect of this embodiment of the present disclosure, virtual marketplace 130 may be programmed to provide for various functions facilitating communication between the first party and the second party. For example, virtual marketplace 130 may categorize the parties and/or information received 140 to better facilitate communication between the parties. Virtual marketplace 130 may also provide separate virtual rooms 160 using, for example, separate links to facilitate communication between first and second parties regarding the development of technology depending on each parties' interest for accessing virtual marketplace 130. For example, virtual marketplace 130 may create separate virtual rooms 160 where the parties can meet and share information. Such virtual meetings can be initiated based on the categorization or ratings, or based on identifiable categories, keywords, and/or topics inputted by parties regarding information 110 and/or resource information 120. For example, virtual rooms 160 may be created for the parties to meet based on the particular type of technology found in the information 110 or the type of transaction desired. Virtual rooms 160 may thus allow transactions between the first party with information 110 and the second party with resource information 120 including, but not limited to selling, licensing, buying, leasing, and/or auctions (open bid, closed bid, hid with time limits. Dutch auctions, and reverse auctions). Consideration within virtual marketplace 130 may include, but is not limited to credit, debit, and equity shares in a company or other entity.

Virtual marketplace 130 may generate revenue. Revenue may come from various methods, such as from advertising 190 on virtual marketplace 130 or memberships. Advertisers may represent any person or entity that desires to advertise on the electronic network, such as the Internet. For example, advertisers may represent online retailers, online service providers, financial institutions, product manufacturers, and/or any other entity that advertises goods or services electronically over a network. Alternatively or in addition, first and/or second parties may pay for access to virtual marketplace 130 with memberships, and the virtual marketplace 130 may be programmed to check for the membership (150 in FIG. 1) of one or both of the first and second parties before facilitating communication between the parties. Parties may agree to pay in to the virtual marketplace 130 on a per visit, or subscription basis; or first parties with information 110 may pay with equity in their company if a deal resulted from their participation at the virtual marketplace 130, for example.

As mentioned above, rating systems may be established 140 so that first and/or second parties may rate the quality of the information 110 and resource information 120 provided by the parties on the site. These ratings may be displayed on virtual marketplace 130 for view by first and/or second parties. Ratings may be used by parties in advertising.

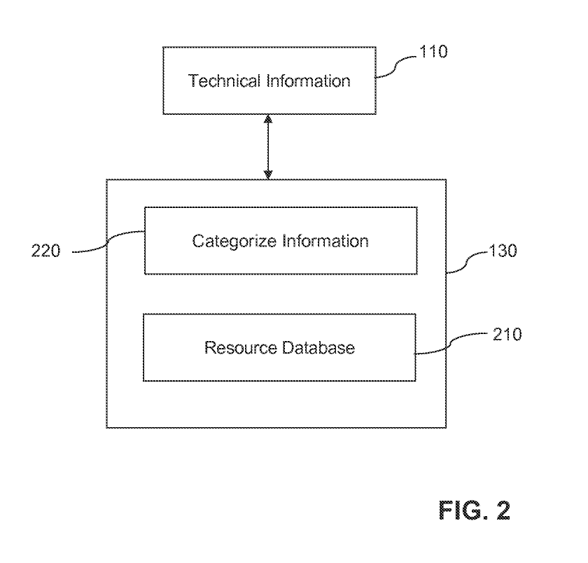

FIG. 2 illustrates another embodiment in which parties may connect, interact, and share information and resources to help promote/develop innovation.

As shown in FIG. 2, first party may again possess information 110 associated with a product it wishes to promote/develop. In this embodiment, virtual marketplace 130 may include a resource database 210 containing an inventory of resource information similar to the resource information 120 discussed above. Resource database 210 may include, but is not limited to, funding information, advice, financing, proposals, research, and other support.

Based on stored resource information within database 210 of virtual marketplace 130, virtual marketplace 130 may compare and match information 110 received from the first party to particular resource information found in resource database 210. When virtual marketplace 130 receives resources, it assigns each resource to a particular category based on certain factors. These factors may include but are not limited to a particular type of technology desired for the resources, for example, mechanical, electrical, environmental, etc. Additionally, when virtual marketplace 130 receives information 110, it also assigns the information 110 to a particular category based on similar factors (see 220 in FIG. 2). Consequently, when virtual marketplace 130 receives information 110 from a first party, virtual marketplace 130 may compare the category where the information was assigned and match the information with a resource in a similar category found in the resource database. The result of this comparison may then be outputted to the first party.

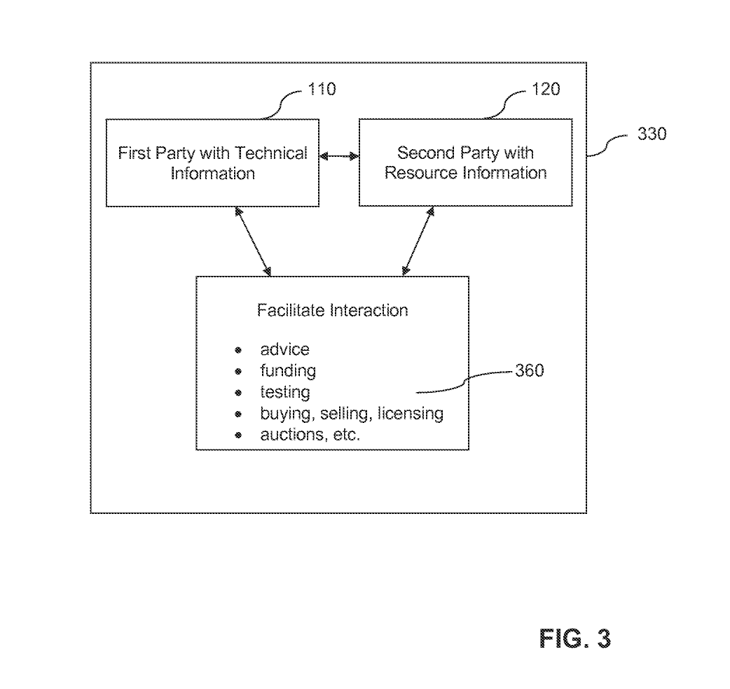

FIG. 3 illustrates another embodiment of the present disclosure in which parties may connect, interact, and share information and resources to help promote/develop innovation. As shown in FIG. 3, first and second parties may meet and engage in a variety of product development tasks and activities in an innovation facility 330. Innovation facility 330 may include a single building or a plurality of closely located buildings, such as those found in a common university. An innovation facility may also be a virtual facility and the descriptions herein of physical security systems, rooms and so forth can also apply to virtual security systems, rooms and other features.

In particular, first party with technical information 110 may wish to promote/develop a product. Second party with resource information 120 may wish to assist in the development of certain technical information 110. The technical information 110 and resource information 120 may include the same information discussed above. The innovation facility 330 may facilitate interaction between the first and second parties regarding the development of the product with the resource information 120 toward a commercial product.

Innovation facility 330 may facilitate interaction between the parties in a number of ways, such as, for example, providing a variety of different rooms or areas 360 for particular interactions. For example, rooms or areas 360 may be used for meetings and provide secretarial support, phones, copying machines and computers with Computer-Assisted Design (CAD) and engineering software. Additionally, rooms or areas 360 may be arranged so that first parties with technical information 110 can meet with and obtain advice on a variety of topics, such as intellectual property issues and/or marketing issues. The rooms or areas 360 may also provide for meetings with research institutions. Additionally, liaisons from Federal and State agencies may help inventors find government funding. Also, there may be high-bay facilities with space and power for basic mechanical and electrical fabrication so that prototypes could be built, tested, and demonstrated within rooms or areas 360. Other transactions that may occur within various rooms or areas 360 include, but are not limited to selling, licensing, buying, leasing, auctions (open bid, closed bid, bid with time limits, Dutch auctions, and reverse auctions).

According to another aspect of this embodiment of the present disclosure, rooms 360 may provide a fast track for promotion of inventions to commercialization. For example, inventors or others wishing to develop a new or improved product may present their ideas and/or inventions and a simple business plan to a panel of experts. After a certain time period, such as ten days, for example, a decision may be reached on whether or not to fund the development of the product and/or business plan. Winners may then immediately receive a substantial grant, which may be spent on activities provided by innovation facility 330. This money may be spent on legal support, engineering advice, and prototyping, for example. The approval process may include a clear outline of the project and a timetable. Funding may be done on a “self-licking ice cream cone” model, used by venture capital firms in which the firm makes an initial investment and receives an equity share or other interest in the company.

According to yet another aspect of this embodiment, innovation facility 330 may be self-funding over time. For example, federal or other types of funding may be used to initiate innovation facility 330 or facilities, for example one or more in each state. With respect to federal funding, such funding may be provided to each state with guidelines for their operation and enough flexibility for the states to create 50 different approaches, so the best-of-breed approaches could be replicated. Every first party receiving a grant may then pay a small percentage of the corresponding company's equity or equivalent monies to the innovation facility 330. If the product facilitated through innovation facility 330 develops into a profitable product, the first and/or second party may then pay back any funds received and/or a profit for the innovation facility 330.

In addition, private venture capital may help fund innovation facilities 330. For example, private venture capital could augment government funds in a private sector-government partnership. Private investment group may raise private funds to co-invest with the government in starting up innovation facilities 330. Alternatively, private investment groups may handle the whole investment itself. This investment fund would be able to pick the best of the best of thousands of promising technical information ideas or inventions 110 and reap a fair profit in return.

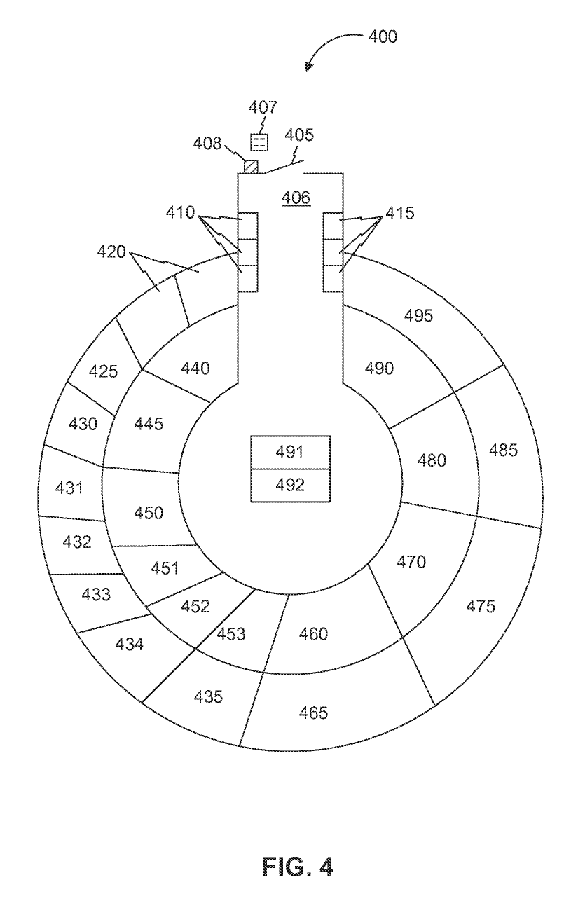

FIG. 4 illustrates an exemplary physical innovation facility 400 (hereinafter referred to as “physical facility 400”). The details about the physical facility 400 as shown in FIGS. 4-10 and discussed below may also be applicable to the innovation facilities 330 discussed above. The physical facility 400 may be a secure facility for promoting innovation development in a secure manner. An inventor, who may be an individual inventor, multiple inventors, or a company, who owns an invention, may come to the physical facility 400, applying for assistance in developing and commercializing the invention. For example, an inventor may seek assistance from the physical facility 400 to turn his/her invention or idea into a real product ready for the market. The term “invention” used herein may also encompass the meanings expressed by the terms “idea” and “innovation,” and therefore, may be exchangeable with the terms “idea” and “innovation.”

The physical facility 400 may make various services available in one place to the inventor, thereby saving the inventor time, energy, and money that would otherwise be wasted by figuring out which service providers would be useful and then going in various locations to different service providers. The services provided by the service providers within the physical facility 400 may include all necessary or key “ingredients” for the inventor to successfully develop and commercialize his/her invention. The services may include at least one of legal services, technical services, assistance on obtaining funding, commercialization assistance, testing, and prototyping. Other services, such as governmental services, marketing, public relations, communications, etc., may also be available within the physical facility 400. The physical facility 400 may facilitate or foster innovation by enabling the inventor to develop and commercialize his/her invention in one convenient place and in a secure manner. The inventor may use resources provided within the physical facility 400 to share information regarding the invention to various service providers (e.g., under confidential or non-disclosure agreements with the service providers to protect information relating to the invention), secure funding for developing the invention, obtain expedited governmental review of relevant export/import regulations and security requirements, and obtain accelerated examination of patent applications of the invention.

While the inventor develops the invention within the physical facility 400, information regarding the invention is protected by various security mechanisms provided within the physical facility 400. For example, only authorized persons may be present within a predetermined proximity to a prototype of the invention, which may relate to critical technologies or national security. In addition, any information stored on a computer network (discussed below) within the physical facility 400 is protected by a security system (discussed below) that restricts access to the information to only those with authorization. Furthermore, the computer network is protected by the security system from cyber attacks originated on the Internet outside of the physical facility 400. Therefore, information regarding the invention is securely stored within the physical facility 400 and protected from being illegally accessed by unauthorized persons, or stolen by an Internet hacker. The physical facility 400 thus provides a secure place for individuals and companies to securely develop and commercialize their inventions, which would ultimately enhance national security of a country and its competitiveness in the global market.

The physical facility 400 may expedite commercialization of innovation. The physical facility 400 may implement a process to help an inventor to develop an idea or invention into a commercial product. The process may be named as, for example, Local Technology Center Program (“LTC Program”). The physical facility 400 may also be referred to as an LTC. The term “process” encompasses methods disclosed in this application. The LTC program may have objectives related to facilitating innovation and commercialization. For example, the LTC program may aim to implement new business methods and new, systematic, disciplined approaches for accelerating the process of commercializing an invention. The LTC program may also aim to achieve at least one of the following goals within 90 days of admitting an inventor into the physical facility 400: establishing a new business entity and making it operational; writing a business plan; filing a patent application for the invention; acquiring first round of funding for the invention; creating engineering drawings (if applicable); building prototypes (if applicable); developing marketing and public relations materials; and exploring first sales opportunities.

A Local Technology Center (LTC), as represented by the exemplary physical facility 400, is an idea commercialization facility. Such LTCs may be distributed around the United States or in each state. Funding for the operation of the LTCs may come from the public and/or the private sectors. For example, the U.S. federal, state, and/or local governments may provide preliminary support for the first few LTCs, like a venture capital investment. As inventions are developed into profitable products within the LTCs, the inventors could pay back the value of services they received from the LTCs, plus certain profit. Such payments could be in any suitable form, such as cash or stock. When the LTC receives stock as a form of payment from the inventor, the LTC may become a stakeholder of the invention.

In order to be successful, the LTC may need to promote itself through various vehicles, e.g., public relations and communications activities, advertising on the Internet, in print media, and TV. The LTC may also have a presence at trade shows, conferences of various academic and industrial fields, universities and educational or scientific programs, federal, state, and/or local government organizations, such as National Science Foundation (“NSF”), Department of Energy (“DOE”), Environmental Protection Agency (“EPA”), and Department of Defense (“DOD”).

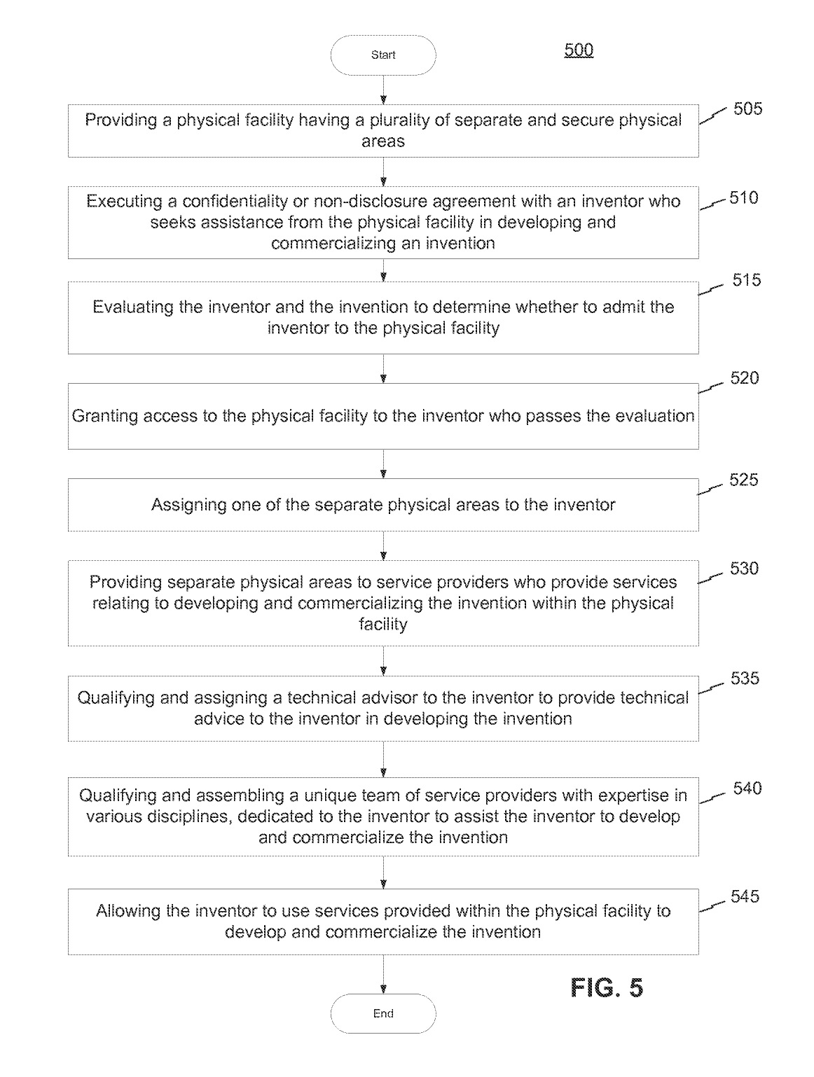

FIG. 5 illustrates a method 500 of expediting commercialization of innovation. Method 500 illustrates at least a portion of the process implemented by the LTC (e.g., the physical facility 400). In some embodiments, the process implemented by the LTC may not include all of the steps shown in FIG. 5. In some embodiments, the process may include more steps that are not shown in FIG. 5, which will be included in below discussion.

The method 500 may include providing a physical facility (e.g., the physical facility 400) having a plurality of separate and secure physical areas (Step 505). The separate physical areas may include offices, workshops, laboratories, cafeteria, printing/copying/scanning areas, demonstration and testing centers, etc. The method 500 may include executing a confidentiality or non-disclosure agreement with an inventor who has an invention to protect information relating to the invention (Step 510). When the inventor comes to the physical facility 400 to seek assistance in developing and commercializing the invention, before the inventor discloses any information relating to the invention to any person from the physical facility 400, the physical facility 400 and the inventor may sign a confidential or non-disclosure agreement to protect the information relating to the invention. The method 500 may also include evaluating the inventor and the invention to determine whether to admit the inventor to the physical facility 400 (Step 515). Before the inventor is admitted to the physical facility 400 to receive services provided by various service providers for assisting the inventor to develop and commercialize the invention, the inventor and the invention may be first evaluated by the LTC to determine the qualification of both the inventor and the invention. If the inventor or the invention does not passes the evaluation, i.e., certain criteria are not satisfied (e.g., the inventor has a criminal record, the invention is unlikely to obtain meaningful patent protection, or the invention is unlikely to have commercial value), the inventor may not be admitted to the physical facility 400 to receive services provided within the facility for developing and commercializing his/her invention.

To start the process, the inventor may first make an appointment with the LTC for the evaluation. The inventor may be required to provide basic background information regarding the inventor and the invention, which is protected by the above-mentioned confidential or non-disclosure agreement. A staff member from the physical facility 400 may verify the information provided by the inventor through various channels. If the verification is satisfactory (i.e., meeting certain threshold criteria, such as no criminal records, the invention appearing to be valuable to the society, technology, or national security), then a live qualification review session may be held by a qualification review board at the LTC. The qualification review board may include one or more persons, e.g., one or more technical experts in a field of technology related to the invention, one or more business persons who are familiar with the market in the field related to the invention, one or more consultants, one or more employees of the physical facility 400, and/or one or more volunteers such as retired persons in the related field. The qualification review board may include paid and volunteer members. For example, the qualification review board may include retired business officials, retired university professors or technical professionals, who may be volunteers. If the qualification review board determines that there is a substantial likelihood of success for the commercialization of the invention, or if there are other grounds for allowing the inventor to use the resources of the physical facility 400, the inventor may be admitted into the physical facility 400 or the LTC program.

Evaluation of the inventor and the invention may be based on a qualification scoring system. The qualification scoring system may assign points to various factors. For example, the scoring system may assign up to 20 points to potential market needs/values by considering the lack of competition in the field, product improvements compared to existing products in the same or similar field, better price point, etc. The scoring system may assign up to 20 points to value of national security by considering the potential impact of the invention relating to national security. For example, if the invention is related to nuclear, military, cyber defense technologies, the invention may be deemed to have a high value of national security and therefore may be assigned more points. The scoring system may assign up to 20 points to the societal value of the invention by considering how much the society may benefit from the invention. The scoring system may also assign up to 20 points to the technological value of the invention by considering the contribution of the invention to technological scientific advancement. The scoring system may also assign up to 20 points to the patentability of the invention, by considering whether there is any conflicting patents or regulatory/legal impediments, such as safety concerns, illegal products, etc. The scoring system may also assign up to 20 points to the investment potential of the invention, by considering reasonable price points being achieved, the likely interest among the investment community, etc. The scoring system may also assign up to 20 points to the quality of management team from the inventor. The scoring system may also assign points to other factors, such as the expertise of the management team in the field of the invention, the experience of the team in running a business, or its ability to form a strong management team with no criminal records, no conflicts of interest, etc. If the inventor and the invention achieve a sufficient score under the scoring system (i.e., higher than a threshold score), the inventor may be qualified to receive support/services from the physical facility 400. Subsequently,the inventor may be admitted to the physical facility 400.

Once the inventor passes the evaluation, the inventor may be required to sign a Services Agreement with the physical facility 400 to participate in the LTC program. The Services Agreement may include various provisions. For example, the Service Agreement may include at least one of the following: the inventor agreeing to pay a fee to the LTC, to purchase a membership of the LTC, to offer a share of equity in the company (which will be established or has been established by the inventor for commercializing the invention) to the LTC, or to grant a license to the LTC to use the technology after the invention is patented, etc. The inventor may be required to agree to collaborate for a period of time, complete inventor's duties on schedule, etc. Both the inventor and the LTC may be obligated to specific duties and responsibilities and may be entitled to certain benefits from each other, which may be defined in the LTC's Services Agreement. The Service Agreement may bind all persons hired or invited by the physical facility 400, including visitors, employees, volunteers, and service providers. Service providers may additionally sign separate agreements with the inventor. The Service Agreement may contain confidentiality or non-disclosure provisions that protect information relating to the inventor's invention. All persons hired or invited by the physical facility 400, as mentioned above, are required to keep information regarding the inventor's invention confidential, and not to disclose such information to a third party without the inventor's consent. The Service Agreement may also acknowledge that the inventor owns the entire rights and interests in the invention, while the invention is developed within the physical facility 400. The Service Agreement may allow the inventor to voluntarily assign a portion of the rights and interests in the invention to the LTC, for example, in lieu of a payment of a fee owed to the LTC. The Service Agreement may further assign, as a default rule, all rights and interests in any improvements of the invention to the inventor while the invention is developed and improved within the physical facility 400, even if some service providers may have contributed to the improvements. Alternatively, in cases where some service providers, such as engineers, have closely collaborated with the inventor in developing the improvements, the Service Agreement may allow the inventor to voluntarily negotiate with the service providers on whether and how they should share the interests in the improvements.

The Services Agreement may be terminated at any stage in the process. If the parties (i.e., the LTC and the inventor) cannot agree to proceed, or one party is in default, the process may be discontinued for that inventor and the termination provisions may become effective. The termination provisions may include, for example, a provision for the inventor to refund (in full or in part) for services received; liquidated damages; damages based on time or expenses incurred prior to termination; return of all property to each party; mutual non-disclosure agreements, etc. According to the relevant provision within the Service Agreement, the LTC may assign one of the separate physical areas to the inventor (e.g., an office or workshop) (Step 525).

Following the execution of the LTC Services Agreement, the LTC may qualify and assign a technical advisor to the inventor to provide technical advice to the inventor in developing the invention (Step 535). The LTC may implement a Technical Advisor System that manages assignments and records of technical advisors. The technical advisor assigned to the inventor may have expertise in the area of the invention or may have other skill sets deemed useful to assist the inventor to develop the invention. Before the technical advisor is assigned to the inventor, the technical advisor may be qualified. Qualifying the technical advisor may include evaluating the technical advisor's expertise to determine whether that expertise will adequately serve the inventor's needs. The technical advisor may provide advice to the inventor regarding the technical aspects of the invention.

The technical advisors may be hands-on coaches for the inventors, which distinguishes the process implemented in the LTC from other computerized process implemented in existing technologies. The technical advisors may be selected, for example, from a core of retired or volunteer professionals, such as corporate or other executives, technical experts from industries, and professors from universities. The Technical Advisor System may include both paid persons and volunteers, full-time and part-time experts as technical advisors. Using a largely volunteer team of experts would reduce costs. The Technical Advisor System may obtain government funding and be modeled on the Teach America Corps or Peace Corps programs. The technical advisors (and the implementation team described below) may meet on a regular schedule with the inventor and others.

The technical advisors may be qualified by the LTC and a roster of qualified technical advisors may be shared among all LTCs. Therefore, the Technical Advisor System across all LTCs may include a database containing information of all qualified technical advisors with their expertise. The technical advisors are those with expertise in various fields of technologies, which is deemed the most useful expertise to the process implemented by the LTCs.

Once the inventor is assigned with a technical advisor, the technical advisor may lead the effort of qualifying and assembling a unique team of service providers with expertise in various disciplines, dedicated to the inventor to assist the inventor to develop and commercialize the invention (Step 540). In some embodiments, the technical advisor may select members of the implementation team for the inventor based on the technology of the invention, the inventor's needs, and the qualification of the service providers. The qualification of the service providers may include security clearance, expertise, price, and capability of meeting the inventor's needs. Depending on the invention and the inventor's need, the implementation team may include lawyers, engineers, financial advisors, marketing advisors, etc. Some inventions may only require promotional support from the public relations and marketing service providers. After the implementation team is assembled, the inventor is allowed to use services provided by the implementation team and other services available in the physical facility 400 to develop and commercialize the invention (Step 545).

The physical facility 400 may provide the inventor with a list of Service Providers with their respective services and fees. The services providers may be evaluated for their qualification before they are admitted to the physical facility 400 to provide services. Various criteria may be used in the evaluation, including, e.g., the service providers' fees, reputation, resources, experience, and quality of services. A scoring system similar to that used for evaluating the inventor may be used for evaluating the service providers. In addition, the service providers may be selected only from those within a predetermined geographical proximity to the physical facility 400. For example, only those service providers who have their main offices or residence from within a predetermined geographical area (e.g., within 20 miles from the physical facility 400) may be considered. This is primarily for the convenience of assembling the dedicated implementation team. For example, when it is required to assemble the team within a short amount of time (such as within 24 or 48 hours in the event that the proposed invention has time sensitive value to national security) of admitting the inventor to the physical facility, service providers who are located nearby may be able to send qualified staff members to the physical facility 400 or bring additional necessary equipment or resources to the physical facility 400. After the service providers are admitted to the physical facility 400, the LTC may provide separate physical areas to service providers who provide services relating to developing and commercializing the invention within the physical facility (Step 530).

Before the service providers are admitted to the physical facility 400, the LTC may require the service providers to sign an agreement with the LTC. The agreement may require the service providers to agree to provide services to the inventor, when such services are needed by the inventor. The service providers may be required to agree to sign a confidential or non-disclosure agreement with the inventor to protect information related to the inventor's invention. The service providers may be further required to assign all rights and interests in any improvements of the invention, to which the service providers may have contributed, to the inventor, unless the inventor voluntarily agrees to share the rights and interests in the improvements with the service providers. Such requirements will provide additional protection to the inventor and incentivize the inventor to use the physical facility 400.

The services provided within the physical facility 400 include at least one of legal services, technical services, assistance on obtaining funding, commercialization assistance, marketing, public relations, communications, testing, and prototyping. Other services, such as training services, may also be available to the inventors. The training services may include management, financial, technical, or operational training. The training services may be provided in various forms, e.g., power points, seminars, classes, webinars, audios, videos, prints, etc.

With advice from the technical advisor assigned to the inventor, the inventor may select one or more service providers from the list and enter into contracts with them for services. In some embodiments, the technical advisor may be in charge of assembling the implementation team consists of key service providers, as discussed above. The Service Providers list may include at least one of the following items: the names, affiliations, and experience of the service providers, the services, and their prices. For example, a lawyer's legal service may include the charge per hour or per task (e.g., a task of creation of a simple Limited Liability Company as the business vehicle for the inventor). The charge may include detailed billing rates for partners, associates, or others. The charge may also include a fixed fee for a particular task. Similar fee arrangements may be applicable to other areas, such as marketing, public relations, engineering, drawings, etc. Various other fee arrangements may also be used. In some embodiments, when the inventor is admitted to the physical facility 400, the inventor may be granted a certain amount of services for free or for a certain fee that the inventor pays upfront. The Service Providers list may include the amount (e.g., in hours or dollars) of services that has already been granted to the inventor. The Service Providers list may be customized for different inventors since different inventors may need different services. The Service Providers list may include all of the services providers available within the physical facility 400.

A variety of research relating to the invention may be performed within the physical facility 400. Such research may be performed by the service providers or the inventor using resources available within the physical facility 400. The research may include a prior art search for existing patents and patent applications relating to the field of the invention, a market search for competing products and/or services available on the market, potential markets for the invention, and information regarding other research or activities in the field of the invention that indicates potential competition or collaboration. The research may also include research for regulatory, legal, safety, compliance, or other issues that may affect the development of the invention and its market success. The research may further include research for national security, environmental impact, and import and/or export issues, such as tariffs and export controls under the Department of State, Department of Commerce, and the International Traffic in Arms Regulations. The research may further include research on foreign ownership control issues, such as the need for review of an investment by the U.S. government's Committee on Foreign Investment in the United States.

The physical facility 400 may assign separate physical areas (e.g., offices) to representatives from business entities (e.g., companies) that are interested in acquiring inventions developed within the physical facility 400, or in providing funding to certain inventions. Business entities (and their representatives) may be qualified first before they are admitted to the physical facility 400. The qualification of the business entities may include, for example, consideration of the business entities' revenue, fields of expertise, and contribution to the LTC. The qualification of the representatives may include, for example, background check, title and authority of the representatives, and expertise. Investors and/or business entities may provide partial or full funding to the inventor for developing his/her invention in exchange for a stake in the invention (or in the company that the inventor sets up for marketing the invention), and subsequently become stakeholders of the invention. The LTC program may assign a priority status to the investors and/or business entities that sponsored or funded the program and/or services, or directly funded the inventions, in accessing information related to the inventions and in acquiring a stake in the inventions.

The LTC itself may become a stakeholder of the invention by receiving a share of equity in the invention in lieu of a payment of a fee for services rendered by the LTC to the inventor, such as administrative support (copying, phone, utility, food, etc.). Some service providers may also become stakeholders by receiving a stake of the invention in lieu of a payment for their services rendered to the inventor. The inventor may have regular meetings with the stakeholders and service providers. The physical facility 400 provides a place for all critical parties to meet on a regular basis to discuss matters relating to the development and commercialization of the invention, including ideas for improving the invention, business matters, funding, marketing, sales, public relations, etc., thereby fostering innovation and facilitating commercialization of an invention.

Service providers and stakeholders may include business lawyers who may help the inventor prepare and file various business documents, and provide consultation to the inventor on business issues, such as the choice of a business entity. Business documents may include Articles of Incorporation, Operating Agreements, and Bylaws. Business lawyers may also help the inventor obtain business licenses from federal, state, and local governments, or obtain Employee Identification Numbers (EINs) from the Internal Revenue Service (IRS).

Service providers and stakeholders may also include patent lawyers. Patent lawyers may provide consultation to the inventor regarding the process for obtaining a patent for the inventor's invention, licensing, and technology transfer. The patent lawyers may also prepare, file, and prosecution patent applications for the inventor. The patent lawyers may provide legal services relating to the patentability analysis of the invention, noninfringement analysis, due diligence, or clearance with respect to the invention. Before the inventor reaches out to potential investors, the inventor may ask the patent lawyers to perform one or more of the above legal services. Other intellectual property lawyers, such as trademark and copyright lawyers may also provide services within the physical facility 400.

Service providers and stakeholders may also include government liaisons, who may work with the inventor on grant programs from various federal, state, or local governments. The inventor may receive information and services from the government liaisons regarding governmental funding opportunities, regulations, and government licenses.

Service providers and stakeholders may also include financial and tax advisors, who may provide consultation to the inventor on financial and tax related issues. For example, the inventor may consult the financial and tax advisors on investment issues, fund management issues, tax issues, and credit/debt issues. The inventor may also use their services to file tax returns or prepare financial documents.

Service providers and stakeholders may also include educational liaisons from universities and other educational institutions that are interested in sharing with the inventor intellectual property they have already developed or wish to develop. For example, the inventor may explore collaboration opportunities with the universities to co-develop certain invention. In addition, the universities may provide educational programs and trainings to the inventor in the field related to the invention. The universities may also provide information regarding their intellectual property which they wish to develop, commercialize, sell, or license. For example, the inventor may obtain a license from the universities to use a patented technology in his/her invention.

Service providers and stakeholders may include marketing advisors who may advise the inventor on marketing issues. The service providers and stakeholders may also include sales and distribution companies that may provide services relating to sales and distribution of a product developed by the inventor. Service providers and stakeholders may also include advertising firms who may provide services for advertising the invention and/or the product developed from the invention. Service providers and stakeholders may also include communications and public relations companies, who may provide services relating to communications and public relations.

Service providers and stakeholders may further include government relations specialists, lobbyists, or foreign agents. The inventor may obtain advice from a government relations specialist on complying with regulations implemented by a particular government agency (such as export controls), or may consult a lobbyist regarding possible government policies. The inventor may also consult a foreign agent on policies regarding a technology field (such as solar energy) in a foreign state.

Service providers and stakeholders may also include liaisons from government laboratories that may be interested in collaborating with the inventor to develop an invention, or acquiring inventions relating to advanced technologies that are developed within the physical facility 400.

Service providers and stakeholders may also include investors, who may include individual angel investors, angel groups, venture capital funds, private equity, hedge funds, government entities such as In-Q-Tel (the Central Intelligence Agency's strategic investment firm), Defense Advanced Research Projects Agency (DARPA), etc. Companies interested in certain technologies may also become investors by sponsoring the LTC program, providing funding to support inventions in certain fields, or providing direct funding to a particular inventor for his/her invention.

Service providers and stakeholders may also include training companies, who may provide training to the inventor. Various types of training may be provided to help the inventor succeed, including, e.g., technical training, business training, operational training, management training, etc. Before training is provided to the inventor, the inventor may be evaluated first, e.g., by the training companies, to determine how much training is needed.

Service providers and stakeholders may also include liaison and meeting services providers who may organize meetings among interested potential partners, suppliers, customers, etc. For example, when the invention has been developed into a product, the inventor may need to meet with suppliers and customers to explore issues relating to the price and market.

Service providers and stakeholders may further include prototyping companies, which may assist the inventor in developing prototypes of the invention. The prototyping companies may include engineers and technical experts mentioned above. Prototypes may be prepared on site within the physical facility 400, e.g., through an indoor or outdoor prototype demonstration and testing center discussed below, or through outside providers, e.g., by outsourcing from a service provider within the physical facility 400. Prototypes may be full scale or scale models. In addition to prototyping services, testing services may also be provided within the physical facility 400 (e.g., through an indoor or outdoor prototype demonstration and testing center discussed below). Testing companies may include engineers or technical experts in various fields. They may include graphical designers who prepare sketches or engineering drawings, such as Computer-Assisted Design (CAD) drawings, for a prototype of the invention. Engineers and technical experts may provide services to assist the inventor build and test the prototype of the invention. Engineers and technical experts may also provide consulting services to help the inventor solve technical questions. Engineers and technical experts may perform various testing on the invention, including, for example, structural testing, vibration testing, noise testing, stress testing, electrical testing, safety testing, etc.

Service providers and stakeholders may further include certification service providers. The invention may need to be certified for various aspects relating to product, safety, and standards in order to accelerate its entrance into the marketplace. The inventor may obtain certification services from one or more service providers within the physical facility 400.

One of the services provided within the physical facility 400 is a program that provides an accelerated patent examination to an invention. Each invention may be rated and compared to other inventions within an LTC or among several LTCs. Those receiving the highest ratings (e.g., among top 10%) may be qualified for receiving a fast track patent examination by the United States Patent and Trademark Office. One or more of the following factors may be considered in the rating to determine whether an invention qualifies to receive the fast track patent examination: whether a prior art search has been performed (and/or whether a search report identifying the allowable features in view of the prior art is available), whether national security and import/export check has been performed, whether the invention has been tested and a satisfactory testing report is available, and whether a prototype of the invention has been bunt. The factors may further include the status of the invention for commercialization, the societal, market, and technological values of the invention. This program may further encourage the use of the LTCs by inventors and others.

Another service provided within the physical facility 400 is a program that gives an invention federal, state, or local government contracting preference. Each invention may be rated and compared to others within an LTC or among several LTCs. Those receiving the highest ratings (e.g., among top 10%) may be given priority status for one of receiving government contract awards, grants, tax incentives, priority in obtaining visas for expert foreign personnel under federal immigration laws, or exemption from other federal regulations and programs. Other privileges under the government contracting or other government regulations may also be awarded to the top rated inventions. This program may further encourage use of the LTCs by inventors and others.

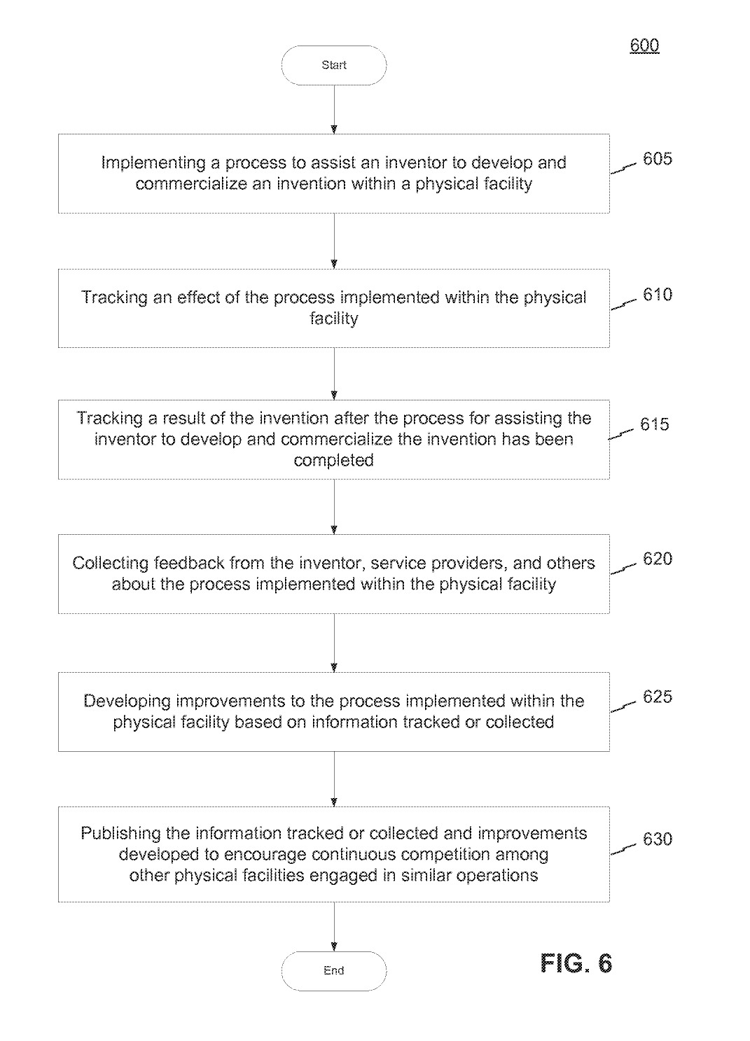

The physical facility 400 (i.e., an LTC) may implement a method to continually improve the process implemented within the facility for assisting an inventor to develop and commercialize an invention within the physical facility 400. FIG. 6 illustrates an exemplary method 600 of fostering continuing best practices in innovation. As discussed above, the physical facility 400 implements a process to assist an inventor to develop and commercialize an invention within the physical facility 400 (Step 605). The method may include tracking an effect of the process implemented within the physical facility 400 (Step 610). The effect of the process may include an overall effect of the process on innovation, economy, technology advancement, and/or national security. The effect may be represented by a score. The higher the score, the greater the effect.

The method may also include tracking a result of the invention after the process for assisting the inventor to develop and commercialize the invention has been completed (Step 615). The result of the invention may be success or failure, or may be a mixed result including success in some aspects and failure in others. For example, the invention may be developed into a product that is successfully commercialized, may fail to reach the commercialization stage but with significant progress in the development stage, or may end up with complete failure. The result of the invention may include at least one of a commercialization or realization result of the invention, a societal value of the invention, a national security value, or a business and/or technological value of the invention.

The method may also include collecting feedback from the inventor, service providers, and others, including, e.g., employees, technical advisors, or volunteers of the physical facility 400, about the process implemented within the physical facility 400 (Step 620). To collect feedback, the LTC may organize meetings with the inventor, the service providers, and others to collect feedback or may use surveys with the inventor, the service providers, and others to collect feedback. Collecting feedback from the inventor, the service providers, and the others may include collecting feedback from both the currently admitted inventors, service providers, and the others, as well as previous inventors, service providers, and others who recently terminated their agreements or collaboration with the LTC. The method may further include developing improvements to the process implemented within the physical facility 400 based on information tracked or collected (Step 625). Developing improvements may use a scoring system to assign a score to the process implemented within the physical facility 400 for assisting the inventor to develop and commercialize the invention. Optionally, the method 600 may include publishing the information tracked or collected and improvements developed to encourage continuous competition among other physical facilities engaged in similar operations (Step 630). After improvements are incorporated into the process and the process is updated or revised, one or more steps 605-630 may be repeated to continually improve the process.

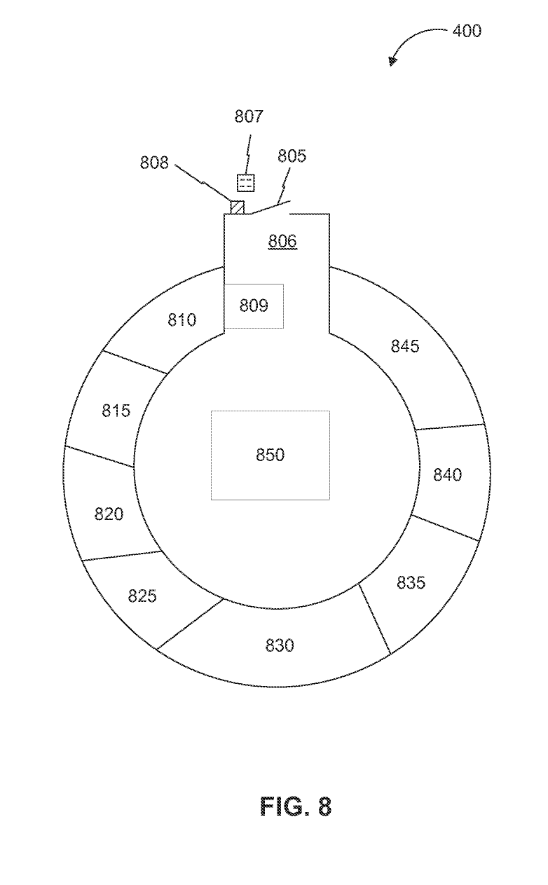

Referring back to FIG. 4, the exemplary physical facility 400 may be a secure physical facility, and may include one or more buildings. For illustrative purposes, the physical facility 400 is shown in FIGS. 4 and 8 as including one building. It is understood that the physical facility 400 may include more than one building located within a secure, enclosed area (e.g., an area enclosed by a security fence). In some embodiments, the physical facility 400 may contain one or more Sensitive Compartmented Information Facilities (SCIF) qualified under federal government directives. At least one of the Sensitive Compartmented Information Facilities (SCIF) is containerized, immediately transportable to a more secure location in the event of a security or other threat, and continuously trackable.

The physical facility 400 may include a door 405 and a plurality of separate physical areas 406-495. The separate physical areas within the physical facility 400 may be accessible to inventors and service providers based on corresponding security policies. At least one of the physical areas may be assigned to an inventor. One or more physical areas may be assigned to the service providers. The separate physical areas may be separate by walls and doors, and may be in the forms of offices, workshops, laboratories, studios, etc.

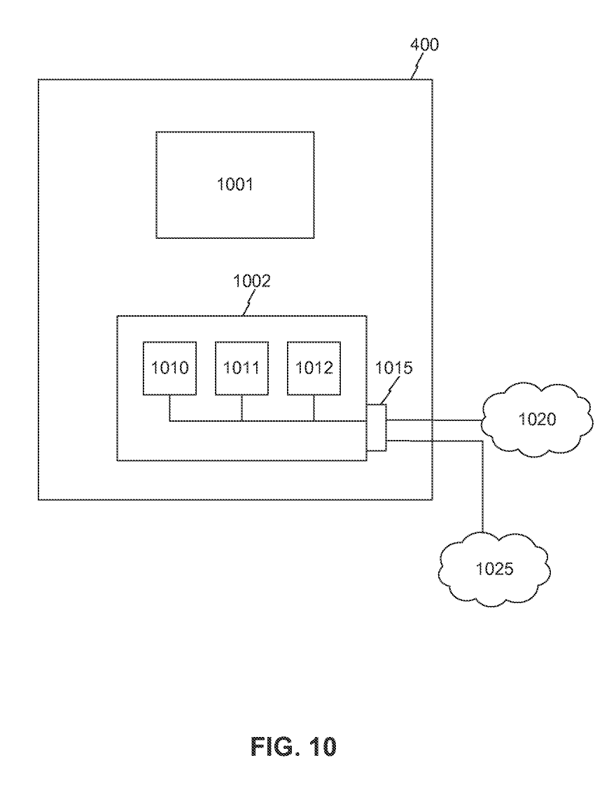

The door 405 may be controlled by an access control system 1001 (shown in FIG. 10 and discussed below). In order for a person to enter the door 405, the person has to either ring a door bell so that a security guard stationed at a reception area 406 may open the door 405 for the person, or scan a security tag or badge 407 (hereinafter referred to as “security badge 407”) at a security tag or badge reading device 408 (hereinafter referred to as “badge reading device 408”) provided near the door 405 outside of the building. If the badge reading device 408 recognizes the security badge 407, the access control system 1001 may open the door 405 for the person. If the badge reading device 408 does not recognize the security badge 407, the access control system 1001 may deny access to the person. The security badge 407 may be any suitable badge, for example, a Radio-Frequency Identification (RFID) badge. The badge reading device 408 may be any suitable badge reader, for example, an RFID reader. Other suitable technologies may also be used for the security badge 407 and the badge reading device 408.

The physical facility 400 may include one or more qualification rooms 410. An inventor who comes to the physical facility 400 with an invention may be evaluated during a personal interview before the inventor can be admitted. The personal interview may be held at one of the qualification rooms 410, and conducted by a qualification review board. The physical facility 400 may include one or more technical advisors offices 415 for one or more technical advisors who may provide advice to the inventor in the technical field of the invention.

As shown in FIG. 4, the physical facility 400 may include one or more proposal presentation rooms 420, which may be used by the inventor to present proposals or inventions to various audience, such as the qualification review board, technical advisors, funding sponsors (e.g., investors or other stakeholders, a potential buyer of the invention, etc. The proposal presentation rooms 420 may be used for other suitable purposes, such as hosting meetings between the inventor and stakeholders, government officials, and other service providers.

The physical facility 400 may include an audio/video production and broadcast studio 425. Studio 425 may include various audio/video equipment for producing audio/video records, files, or data streams. Studio 425 may also be used for developing an invention relating to audio/video systems, or may be used for broadcasting information internally within the physical facility 400. For example, studio 425 may be used for disseminating audio/video data to electronic devices within the physical facility 400 via emails, other messages, and TV channels, etc. The inventor may obtain services from the studio 425, for example, to make or broadcast an audio/video file regarding the inventor's invention, such as a video file showing how the invention works, or a video file for marketing the invention.

The physical facility 400 may include at least one physical area 430 (e.g., an office or workshop) assigned to an inventor. The inventor may work in physical area 430 to develop and commercialize the invention and to communicate with the service providers within the physical facility 400. The physical area 430 may be equipped with telephone, internet, computer, printer, or scanner for the inventor to use. The physical facility 400 may include a plurality of collaboration rooms 431-435. The collaboration rooms 431-435 may be used by the inventor to work with service providers, such as engineers, technical advisors, investors, marketing and financing/commercialization firms to develop and commercialize the invention. Collaboration rooms 431-435 may be used for any other suitable purposes, such as for holding meetings among the inventor and service providers.

The physical facility 400 may include an academic stakeholder office 440. The academic stakeholder office 440 may include one or more separate offices for housing representatives from academic stakeholders, such as universities and other research/educational institutes. The inventor may interact with the academic stakeholder office 440 for various purposes, for example, obtaining funding from an academic stakeholder, seeking a joint research opportunity with an academic institute, or negotiating a license to use a technology developed by the universities.

The physical facility 400 may include a government office 445. The government office 445 may include one or more separate offices for representatives from different government agencies, such as Food and Drug Administration, United States Patent and Trademark Office, U.S. Customs, etc. Various other federal, state, or local government agencies may also have representatives in the physical facility 400. The inventor may obtain services from these government agencies. For example, the inventor may apply for permits or licenses, obtain an expedited review of relevant import/export security regulations and security requirements related to a product developed from the invention, obtain information relating to patent application. By housing various government entities in one place, the LTC may enable the inventor conveniently obtain services from different government entities. The synergies created would facilitate the process of commercializing an invention.

The physical facility 400 may include a plurality of offices 450-453 for housing law firms, investors, financial advisors, etc. The physical facility 400 may include as many offices as needed for housing these and other service providers. The inventor may obtain legal services from law firms, including lawyers specialized in patents, trademarks, copyrights, contracts, business laws, etc. The inventor may obtain funding from investors. The inventor may obtain partial or full funding from the investors and may convey, in exchange for the funding, stock or a certain share of equity in the invention to the investors. The investors may include venture capital firms, banks, angel investors, companies, and universities, who may be interested in acquiring a stake in the invention and the product to be developed from the invention. The inventor may consult the financial advisors for issues relating to finance.

The physical facility 400 may include one or more secure rooms. For example, physical facility 400 may include a first secure room 460 and a second secure room 465. The secure rooms 460 and 465 may provide additional security, and may only be accessible by authorized persons. The secure rooms 460 and 465 may be used for storing a prototype of an invention. The secure rooms 460 and 465 may also be used for confidential collaboration between the inventor and one or more of the service providers, such as government agencies, law firms, investors, and engineers, which may require a heightened security. Activities and discussions occurred within the secure rooms 460 and 465 may be protected from being overheard by unauthorized persons. Things stored within secure rooms 460 and 465, such as a prototype of the invention, may be prevented from being accessed by an unauthorized person.

The physical facility 400 may include one or more rooms 470 and 475 for marketing, public relations, and communications service providers. The inventor and/or the marketing, public relations, and communications service providers may use rooms 470 and 475 to work together on a project relating to marketing a product, public relations, or communications with certain parties.

The physical facility 400 may include one or more rooms 480 and 485 for engineering and science offices, assigned to engineering and/or scientific service providers. The inventor may consult a professional on certain technical issues, or obtain a computer-aided design (CAD) drawings for his/her invention. Rooms 480 and 485 may include various types of engineering equipment, such as tools, machines, printers (including 3D printers), experimental equipment, etc.

The physical facility 400 may include one or more rooms 490 and 495 for housing other stakeholders or persons in the field of consumer products, safety, medical, and transportation, etc. For example, the inventor may meet with stakeholders to discuss various issues relating to the commercialization of his/her invention. The inventor may obtain services from the persons in the field of consumer products, safety, medical, and transportation, etc.

The physical facility 400 may include an administrative support office 491, which may house administrative support staff. The physical facility 400 may include an office 492 for providing support services for stakeholders. For example, office 492 may help stakeholders arrange meetings with the inventor and other persons, such as government agencies. The office 492 may also help stakeholders prepare documents for obtaining a stake in the invention developed by the inventor. Office 492 may provide any other suitable services to support the stakeholders, for example, printing, copying, and scanning services.

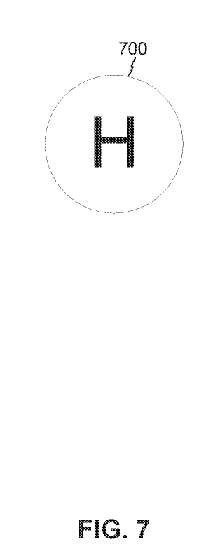

As shown in FIG. 7, the physical facility 400 may include a helipad 700. The helipad 700 may be located on a roof top of the physical facility 400. The helipad 700 may also be located at an open space, such as a lawn or yard of the physical facility 400. The helipad 700 may be used by a helicopter for landing/taking off. For example, during an emergency situation, the helipad 700 may be used by helicopters to transport important documents/equipment (such as those critical to national security or intelligence) and persons out of the physical facility 400 to a more secure place. The physical facility 400 may include a fast response security team, which may be responsible for handling emergency situations, and may utilize the helipad for evacuating people and documents/equipment.

FIG. 8 schematically illustrates an exemplary floor plan of a ground floor of the physical facility 400. The physical facility 400 may include a door 805, which may be similar to the door 405 on the first floor shown in FIG. 4. The physical facility 400 may include a security tag or badge reading device 808, which may be similar to the badge reading device 408 shown in FIG. 4. A person may have to scan a badge 807 at the badge reading device 808 in order to open the secure door 805 to access the physical facility 400. Although not shown in FIGS. 4 and 8, a plurality of security badge reading devices similar to the security badge reading devices 408 and 808 may be disposed in various locations within the physical facility 400. For example, each separate area may include a door that is controlled by a security badge reading device. A person may have to scan his/her badge in order to open a door to access the separate physical area. Such security badge reading device may communicate with security tags attached to prototypes, thereby allowing the access control system (discussed below) to have knowledge of the location of the prototypes.

Similar to the floor plan of the first floor shown in FIG. 4, the physical facility 400 may include a reception area 806 next to the door 805 on the ground floor. The physical facility 400 may include a security staff office 809 for security guards. Security staff office 809 may include equipment for monitoring and controlling access to separate physical areas within the physical facility 400.

The physical facility 400 may include an expansion area 810 for future use. For example, the expansion area 810 may be reserved for housing a future laboratory. The physical facility 400 may include a machine and prototyping shop 815 that provides facility, such as machines and tools, for performing machining of mechanical objects and prototyping inventions. The machines may also make mechanical objects for other purposes, such as, for building customized testing/experimental structures for testing the inventions.

The physical facility 400 may include a cafeteria 820 and a private reception area 825. The private reception area 825 may be used for private events, such as social events hosted by an inventor, a company sponsoring the LTC programs, a service provider, or the LTC itself. Such social events may provide opportunities for the inventors to meet with other inventors, potential buyers, investors, and collaborators.

The physical facility 400 may include a secure design, engineering, and testing area 830, where design, engineering, and testing services may be performed for an invention in a secure manner. The secure design, engineering, and testing area 830 may be highly restricted. The physical facility 400 may restrict access to the secure design, engineering, and testing area 830 to only inventors and service providers who have a relationship to the invention being designed, engineered, and tested within the area 830.

The physical facility 400 may include an office 835 assigned to a representative from a company that is interested in funding inventions or sponsoring programs in the physical facility 400. A plurality of companies may be interested in the LTC program, and each may have an office for its representatives. Through these representatives, companies who are interested in acquiring certain inventions may have direct exposure to hundreds of inventions developed within the physical facility 400. The representatives may have direct discussions and negotiations with relevant inventors on issues relating to funding, acquisition of a stake in the invention, licensing, and commercialization of the invention. If the companies have provided direct funding to the inventors, or have sponsored the programs of the physical facility 400, the companies may be given priority status in accessing information related to the inventions and/or in acquiring certain inventions.

The physical facility 400 may include an information systems and computer laboratory 840 that provides facility for performing computer related research, experiment, and/or testing. For example, engineers and inventors may use super computers or servers included in the information systems and computer laboratory 840 to develop and run computer programs and codes relating to inventions.

The physical facility 400 may include a chemistry biology area 845 that provides facility for performing chemistry and/or biology related research, experiment, and/or testing. An inventor having an invention in chemistry and/or biology may perform research, experiment, and/or test using the facility provided within the chemistry biology area 845. Chemistry/biology related service providers may also use the facility provided within the chemistry biology area 845 to carry out services related to chemistry/biology technologies.

The physical facility 400 may include an administrative support office 850, where the inventors and service providers may obtain services relating to administrative support. Although not shown in FIG. 8, the physical facility 400 may include other laboratories, such as semiconductor technology laboratory, air and space technology laboratories, environmental laboratories, energy laboratories, etc.

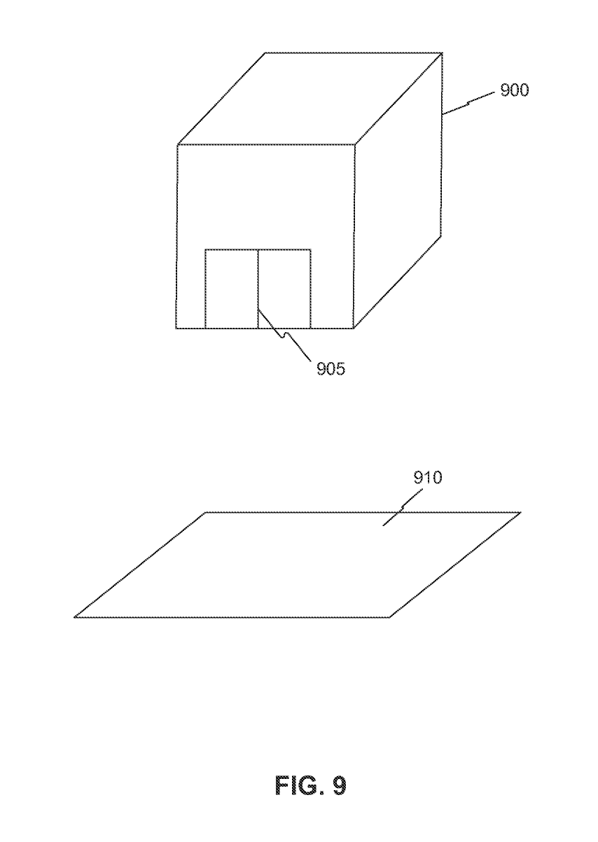

FIG. 9 schematically illustrates exemplary indoor and outdoor prototype demonstration and test centers, where the inventor may perform at least one of the following activities to develop the invention: developing computer codes or computer assisted design (CAD) programs related to the invention, performing research and testing related to the invention, or developing a prototype of the invention. As shown in FIG. 9, the physical facility 400 may include an indoor prototype demonstration and test center 900. The prototype demonstration and test center 900 may be a high-bay facility, which may have a ceiling as high as 60 feet (or with any other suitable height). The high-bay facility may include a door 905, which may be as high as 30 feet (or any other suitable height). The indoor prototype demonstration and test center 900 may be in the same building as the one shown in FIGS. 4 and 8, or may be in a separate building of the physical facility 400.

The physical facility 400 may include an outdoor prototype demonstration and test center 910. The outdoor prototype demonstration and test center 910 may be located outside of the building shown in FIGS. 4 and 8. For example, the outdoor prototype demonstration and test center 910 may be located on an open field of the physical facility 400. At the indoor and outdoor prototype demonstration and test centers 900 and 910, prototypes of inventions may be demonstrated to visitors, potential buyers, company representatives, or other stakeholders. In addition, prototypes may be tested using equipment provided within the indoor or outdoor test center 900 or 910. For example, some prototypes of inventions may require a large space to house a large test structure, and the high-bay indoor prototype demonstration and test center 900 or the outdoor prototype demonstration and test center 910 may have enough space to accommodate the test structure.

FIG. 10 schematically illustrates security related systems provided within the physical facility 400. The physical facility 400 may include an access control system 1001, which may implement security policies for controlling access by any person to the physical facility 400 and the separate physical areas within the physical facility 400. For example, the access control system 1001 may include hardware and/or software components to implement the security policies to control access to the one of the physical areas assigned to the inventor (e.g., physical area 430), control access to one or more physical areas assigned to the service providers, and restrict access to other physical areas within the physical facility 400.

For example, access control system 1001 may control access by the service providers to the physical area 430 assigned to the inventor based on relationships between the service providers and the inventor. The security policies may define the relationships between the service providers and the inventor, and may grant the service providers various levels of access to the physical area 430 assigned to the inventor based on the relationships. For example, an engineer who has been hired by the inventor to help develop the invention may be granted access to the inventor's physical area 430 so that they can work together on the invention. A government agency may not be granted access to the inventor's physical area 430 if there is no relationship between the government agency and the inventor that justifies the grant of access. Access to the physical area 430 assigned to the inventor by other persons, such as employees of the physical facility 400 and visitors, may also be restricted by the access control system 1001 based on their relationships with the inventor. Among inventors who are admitted to the physical facility 400, the access control system 1001 may restrict their access to each other's physical area, if there is no relationship between two inventors that justifies the grant of access.

The access control system 1001 may control access to the one or more physical areas assigned to the service providers. For example, the access control system 1001 may allow an inventor to access physical areas assigned to a service provider based on their relationship. An inventor may be granted full or limited access to the physical areas assigned to the service provider if there is a collaboration or contractual relationship between them. An inventor may not be granted access to the physical areas of the service provider if the inventor has no relationship with the service provider. Access to the physical areas of the service provider by other people, such as employees of the physical facility 400 and visitors, may also be restricted by the access control system 1001 based on their relationships with the service provider.

Access to other physical areas within the physical facility 400 by the inventor, the service providers, and others, such as employees of the physical facility 400 and visitors, may also be restricted by the access control system 1001 based on each person's relationship to the physical areas or persons associated with the physical areas. For example, the access control system 1001 may limit access to the secure rooms 460 and 465, if the person desiring to have access does not have a relationship with the secure rooms 460 and 465 that justifies the grant of the access. For example, an inventor may have requested to reserve the secure room 460 to have a confidential discussion with a government agency between 9:00 am. to 10:00 am. on a certain day, the access control system 1001 may allow the inventor and the government agency to access the secure room 460 only for the specific time period on that specific day. For another example, if the inventor has a prototype stored in a storage space within the secure room 460, the access control system 1001 may grant access to the inventor to access only the specific storage space within the secure room 460, but not other storage space that may store prototypes belonging to other inventors. If there is no relationship between the inventor and the secure rooms justifying a need to grant access, access control system 1001 may not grant any access to the inventor.

The security policies may define what areas the inventor, the service providers, and others are allowed to access or be present. The security policies may also define the time the inventor, the service providers, and others may be present at an area within the physical facility 400. The access control system 1001 may assign a security tag or badge to each of the inventors, the service providers, and others within the physical facility 400. The security tag or badge may define which physical areas each person can access within the physical facility 400 based on the security policies. The security policies for controlling access of each person may be coded within the security badge 407 or 807 associated with that person. When a person bearing the security badge 407 or 807 is at a room the person has no right to access, the security badge 407 or 807 may provide a security alert to the access control system 1001 to indicate the violation. The access control system 1001 may also assign a security tag to a prototype of an invention developed by an inventor. The security tag may be affixed or attached to the prototype, and may define where the prototype may be present within the physical facility 400, with which person the prototype may be present within a predetermined distance or time period, or when the prototype may be present in a physical area with a certain person. Such definition may be based on the relationships between the inventors (and the inventions), service providers, and others.

For example, the inventor may not be allowed to access a secure room storing a prototype of an invention developed by another inventor, or may not be allowed to be in the same room as, or within a predetermined distance from, the prototype developed by another inventor. A lawyer representing one inventor may not be allowed to be present within a certain proximity of a prototype developed by another inventor, or the lawyer may not be allowed to be present in a room at the same time as the prototype developed by another inventor. When two persons or one person and a prototype are present in a same room in violation of the security policies, either the security tag associated with the prototype or the security tag or badge associated with the persons, or both, may provide an alert to the access control system 1001 to indicate the violation.

The security tag associated with the prototype may include an RFID tag, and the physical facility 400 may include at least one RFID reading device, e.g., RFID badge reading device 408. Similarly, the security badge associated with a person may include an RFID badge. Other types of security tags and tag reading devices may also be included in the physical facility 400. With the RFID tag attached to the prototype of the invention and the RFD badge carried by the person, the access control system 1001 may know the exact location of the prototype or the person at any time. Thus, when a person having no right to be present within a predetermined distance from the prototype, the access control system 1001 may provide an alert to security personnel and/or the person so appropriate measures may be taken to protect the prototype. In this way, the prototype of the invention may be securely stored and prevented from being approached or observed by unauthorized persons.

As shown in FIG. 10, the physical facility 400 may include a computer network 1002. The computer network may include both wired (e.g., LAN) and wireless connections (e.g., WiFi). The computer network 1002 may include various devices interconnected with each other. For example, the computer network 1002 may include a plurality of servers 1010-1012 to securely store data, including information relating to the invention. Servers 1010-1012 may include a plurality of computers, each of the computers may include a plurality of storage devices, such as hard drives, memory drives, etc., for storing information related to the inventor, the invention, the relationships between the inventor and the service providers and stakeholders, etc. The computers may include processors for executing various computer programs, codes, and instructions. Methods disclosed within this application may be implemented through one or more computers, and may be programed as computer codes or software encoded or embodied in nontransitory computer-readable media, such as memory drives, hard drives, Compact Disk (“CD”), Digital Video Disc (“DVD”), or Blu-Ray Disc. Although not shown in FIG. 10, the computer network 1002 may include other devices, such as network printers/copying machines/scanners, etc.

The computer network 1002 may include hardware and/or software components to implement the security policies to limit access to the data stored therein, including the information relating to the invention. For example, the computer network 1002 may allow a service provider to access information relating to the invention stored on servers 1010-1012 based on a relationship between the service provider and the inventor and his/her invention. If the service provider has no relationship with the inventor, the computer network 1002 may not allow the service provider to access information relating to the invention stored on the computer network 1002. If the service provider has a relationship with the inventor and the invention, the computer network 1002 may allow the service provider to access certain information relating to the invention depending on their relationship. For example, a patent lawyer may have access to a high level description and drawings related to the invention. An engineer who is contracted with the inventor to perform prototyping and testing of the invention may have access to more details about the technical aspects of the invention.

The computer network 1002 may be connected to the Internet 1020 via a cyber security system 1015. The security system 1015 may include various security hardware (e.g., firewalls, gateways) and security software for protecting the computer network from cyber attacks originated from outside of the physical facility 400. This will protect information related to the invention stored on the computer network 1002 from being stolen by malicious hackers. Accordingly, inventors (including individuals and companies) may develop inventions in a secure manner, which in turn enhances a country's technological competitiveness and national security. In some embodiments, the computer network 1002 may be securely connected to selected critical defense, homeland security, and intelligence systems 1025. This may allow national defense and intelligence agencies to take preventive or remedial measures in a timely manner in response to cyber attacks against the computer network 1002 within the physical facility 400, thereby protecting information relating to critical technologies from been stolen or destroyed.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A secure physical facility for promoting innovation development in a secure manner, comprising:
a plurality of separate physical areas within the physical facility accessible to inventors and service providers based on corresponding security policies, wherein one of the physical areas is assigned to an inventor and one or more physical areas are assigned to service providers who provide services relating to developing and commercializing an invention of the inventor within the physical facility;
an access control system that implements the security policies to
control access to the one of the physical areas assigned to the inventor;
control access to the one or more physical areas assigned to the service providers; and
restrict access to other physical areas within the physical facility; and
a computer network that
includes servers to securely store information relating to the invention;
implements the security policies to limit access to the information relating to the invention; and
includes a security system that protects the computer network from cyber attacks originated from outside of the physical facility,
wherein the separate physical areas comprise at least one secure indoor or outdoor prototype demonstration and testing center for the inventor to develop and/or test a prototype of the invention.

2. The secure physical facility of claim 1, wherein the services comprise at least one of legal services, technical services, assistance on obtaining funding, commercialization assistance, testing, and prototyping.

3. The secure physical facility of claim 1, wherein the invention relates to national security.

4. The secure physical facility of claim 1, wherein the secure physical facility contains a Sensitive Compartmented Information Facility (SCIF) qualified under federal government directives.

5. The secure physical facility of claim 1, wherein at least one of the Sensitive Compartmented Information Facilities (SCIF) is containerized, immediately transportable to a more secure location in the event of a security or other threat, and continuously trackable.

6. The secure physical facility of claim 1, wherein the secure physical facility includes one of a fast response security team and a helipad.

7. The secure physical facility of claim 1, wherein the computer network is securely connected to selected critical defense, homeland security, and intelligence systems.

8. The secure physical facility of claim 1, wherein the access control system assigns a security tag to a prototype of the invention developed by the inventor within the physical facility, the security tag defining where the prototype can be present within the physical facility or with which person the prototype can be present within a predetermined distance or time period.

9. The secure physical facility of claim 1, wherein the access control system assigns a security tag or badge to each of the inventors and service providers, the security badge defining which physical areas each of the inventors and the service providers can access within the physical facility and providing security alerts for any violations.

10. The secure physical facility of claim 8, wherein the security tag comprises an RFID tag and the physical facility includes at least one RFID reading device.

11. The secure physical facility of claim 9, wherein the security badge comprises an RFID badge and the physical facility includes at least one RFID reading device.

12. The secure physical facility of claim 1, further comprising at least one of:
a chemistry biology area that provides facility for performing chemistry and/or biology related research, experiment, and/or testing;
an information systems and computer laboratory that provides facility for performing computer related research, experiment, and/or testing;
a secure design, engineering testing area that provides facility for performing design and/or engineering testing; or
a machine and prototyping shop that provides facility for performing machining of mechanical objects and prototyping inventions.

13. The secure physical facility of claim 1, further comprising at least one of:
an audio/video production and broadcast studio;
a technical advisor office for a technical advisor who provides technical advices to the inventor;
an office for a law firm representative;
an office for an investor;
an office for a government agent;
an office for a financial advisor;
an office for a marketing and commercialization firm;
a meeting room; or
a qualification room where an evaluator determines whether to admit the inventor and/or a service provider.

14. A method of expediting commercialization of innovation, comprising:
providing a physical facility having a plurality of separate and secure physical areas;
executing a confidentiality or non-disclosure agreement with an inventor who seeks assistance from the physical facility in developing and commercializing an invention;
evaluating the inventor and the invention to determine whether to admit he inventor to the physical facility;
granting access to the physical facility to the inventor who passes the evaluation;
assigning one of the separate physical areas to the inventor; and
providing separate physical areas to service providers who provide services relating to developing and commercializing the invention within the physical facility, wherein the services include at least one of legal services, technical services, assistance on obtaining funding, commercialization assistance, testing, and prototyping,
wherein the inventor obtains services from at least one of the service providers to develop and commercialize the invention within the physical facility.

15. The method of claim 14, further comprising:
qualifying and assembling a unique team of service providers with expertise in various disciplines, dedicated to the inventor to assist the inventor to develop and commercialize the invention.

16. The method of claim 14, wherein evaluating is performed based on a scoring system that assigns points to factors including at least one of value to society, value to national security, patentability, potential market value, investment potential, and quality of management team.

17. The method of claim 14, further comprising:
qualifying and assigning a technical advisor to the inventor to provide technical advice to the inventor in developing the invention.

18. The method of claim 17,
wherein the technical advisor is a retired or volunteer corporate or other executive with expertise in a field related to the invention.

19. The method of claim 14, further comprising:
evaluating and training the inventor in at least one field related to business management, finance, or business operation.

20. The method of claim 14, further comprising:
evaluating the service providers.

21. The method of claim 14, further comprising:
providing at least one of a laboratory, workshop, or prototype demonstration and testing center for the inventor to perform at least one of the following activities to develop the invention: developing computer codes or computer assisted design (CAD) programs related to the invention, performing research and testing related to the invention, or developing a prototype of the invention.

22. The method of claim 14, further comprising:
facilitating a review of relevant export and/or import regulations and security requirements related to a product developed from the invention,

23. The method of claim 14, further comprising:
rating the invention based on a scoring system that assigns a score to the invention; and
obtaining a fast track patent examination to inventions receiving high scores.

24. The method of claim 23, further comprising:
determining whether to obtain the fast track patent examination for the invention based on at least one of the following factors:
whether a prior art search has been performed,
whether national security and import/export check has been performed,
whether the invention has been tested and a satisfactory testing report has been provided,
whether a prototype of the invention has been built, and status of the invention for commercialization.

25. The method of claim 23, further comprising:
assigning a high priority status to inventions receiving high scores to allow them priority for one of receiving government contract awards, grants, tax incentives, priority in obtaining visas for expert foreign personnel under federal immigration laws, or exemption from other federal regulations and programs.

26. The method of claim 14, wherein the inventor and the service providers are from areas within a predetermined geographical proximity around the physical facility.

27. The method of claim 15, wherein the team of service providers comprises service providers from within a predetermined geographical area.

28. The method of claim 14, wherein assembling the team of service providers comprises assembling the team within a predetermined amount of time.

29. The method of claim 14, further comprising:
providing offices for and qualifying representatives from business entities that are interested in acquiring inventions developed within the physical facility;
allowing the business entities to sponsor or fund programs and/or services provided within the physical facility or to directly fund the invention being developed by the inventor; and
assigning a priority status to the business entities that sponsored or funded the program and/or services or directly funded the invention, in accessing information related to the invention and in acquiring a stake in the invention.

30. A method of fostering continuing best practices in innovation, comprising:
implementing a process to assist an inventor to develop and commercialize an invention within a physical facility, wherein the process includes services provided by service providers;
tracking an effect of the process implemented within the physical facility;
tracking a result of the invention after the process for assisting the inventor to develop and commercialize the invention has been completed;
collecting feedback from the inventor, service providers and others about the process implemented within the physical facility;
developing improvements to the process implemented within the physical facility based on information tracked or collected; and
publishing the information tracked or collected and improvements developed to encourage continuous competition among other physical facilities engaged in similar operations.

31. The method of claim 30, wherein tracking a result of he invention comprises tracking at least one of;
a commercialization or realization result of the invention;
a societal value of the invention;
a national security value; or
a business and/or technological value of the invention.

32. The method of claim 30, wherein collecting feedback from the inventor and the service providers comprises at least one of:
meeting with the inventor, the service providers, and others to collect feedback; or
using surveys with the inventor, the service providers, and others to collect feedback.

33. The method of claim 30, wherein developing improvements comprises:
assigning a score to the process provided to the inventor for assisting the inventor to develop and commercialize the invention.
